(19) United States
(12) Patent Application Publication
(10) Pub. No.: US 2018/0249017 A1
(43) Pub. Date: Aug. 30, 2018

(54) Data Usage Based Data Transfer Determination

(71) Applicant: Microsoft Technology Licensing, LLC, Redmond, WA (US)

(72) Inventor: Mohammed M. Karam, Newcastle, WA (US)

(73) Assignee: Microsoft Technology Licensing, LLC, Redmond, WA (US)

(21) Appl. No.: 15/443,169

(22) Filed: Feb. 27, 2017

(51) Int. Cl. H04M 15/00; H04W 4/24; H04L 12/14

(52) U.S. Cl. CPC H04M 15/8351; H04W 4/24; H04M 15/8214; H04M 15/852; H04L 12/1435

(57) ABSTRACT

A data usage recommendation system monitors data usage of a computing device on a network over a time period. The data usage recommendation system is aware of a data usage limit on the network over the time period, and determines whether the computing device is on track to not exceed the data usage limit during the time period. The data usage recommendation system, based on whether the computing device is on track to not exceed the data usage limit during the time period, can provide recommendations to a program regarding whether to transfer data over the network. Additionally or alternatively, the data usage recommendation system can manage or direct the transfer of data over the network based on whether the computing device is on track to not exceed the data usage limit during the time period.

### BACKGROUND

As computing technology had advanced, mobile computing devices such as smart phones, tablets, and laptops have become increasingly popular. These mobile computing devices typically transfer data to and/or from other devices (e.g., services) via a network. However, this transferring of data is not without its problems. One such problem is that a financial cost to the user is oftentimes associated with this transferring of data. This ongoing cost, in addition to the cost of the mobile computing device itself, can lead to user frustration with their mobile computing device.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, an amount of data usage on a network by a computing device over a time period is monitored. A request for a recommendation regarding whether to transfer data over the network is received from a program, the data being one of multiple classes. Based on the amount of data usage and a data usage limit on the network for the time period, whether the computing device is on track to not exceed the data usage limit during the time period is determined. The recommendation is generated based on the class of the data and whether the computing device is on track to not exceed the data usage limit during the time period, and the recommendation is provided to the program.

In accordance with one or more aspects, an amount of data usage on a network by the computing device over a time period is monitored. A request to transfer data over a network is received from a program, the request including an indication of a class of the data. Based on the amount of data usage and a data usage limit on the network for the time period, whether the computing device is on track to not exceed the data usage limit during the time period is determined. Based on the class of the data and whether the computing device is on track to not exceed the data usage limit during the time period, an opportunity to transfer the data is determined, and the data is transferred at the determined opportunity.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example system implementing the data usage based data transfer determination in accordance with one or more embodiments.

FIG. 2 illustrates an example chart for determining whether the computing device is on track to not exceed the data usage limit in accordance with one or more embodiments.

FIG. 3 illustrates another example chart for determining whether the computing device is on track to not exceed the data usage limit in accordance with one or more embodiments.

FIG. 4 illustrates another example chart for determining whether the computing device is on track to not exceed the data usage limit in accordance with one or more embodiments.

FIG. 5 is a flowchart illustrating an example process for implementing the data usage based data transfer determination in accordance with one or more embodiments.

FIG. 6 is a flowchart illustrating another example process for implementing the data usage based data transfer determination in accordance with one or more embodiments.

FIG. 7 illustrates an example system generally that includes an example computing device that is representative of one or more systems and/or devices that may implement the various techniques described herein.

### DETAILED DESCRIPTION

Data usage based data transfer determination is discussed herein. A computing device has access to a network for which the computing device has a data usage limit over some time period. For example, the network can be a cellular data network and the time period can be a billing cycle (e.g., a user signs up for a data plan allowing 20 gigabytes of data usage without incurring additional overage charges). A data usage recommendation system monitors the data usage of the computing device on the network over the time period, and based on this monitored data usage can provide recommendations to a program regarding sending and/or receiving data. The data usage recommendation system can additionally or alternatively direct the sending and/or receiving of data based on this monitored data usage.

The data usage recommendation system is aware of the data usage limit and the time period, and determines whether the computing device is on track to not exceed the data usage limit during the time period. The data usage recommendation system generates a recommendation regarding whether a program should send and/or receive data, or directs the sending and/or receiving of data for the program, based on whether the computing device is determined to be on track to not exceed the data usage limit during the time period. The data usage recommendation system can also use various additional information to generate such a recommendation or determination, such as an amount of data to be sent or received, an expiration time for sending or receiving data, and so forth.

In one or more embodiments, the data usage recommendation system receives a request from a program on the computing device for a recommendation regarding whether to transfer (e.g., send or receive) data having a particular class. Based on the class and whether the computing device is on track to not exceed the data usage limit during the time period, the data usage recommendation system generates and returns a recommendation to the program. The recommendation can also be generated based on an amount of data (e.g., whether the computing device would still be on track to not exceed the data usage limit during the time period if the requested amount of data were transferred at the current time). The recommendation is to transfer the data at the current time, or to delay transferring the data. The program can then choose whether to follow the recommendation. For example, if the computing device is on track to not exceed the data usage limit during the time period, then the data usage recommendation system recommends transferring the data at the current time. However, if the computing device is on track to exceed the data usage limit during the time period, the data usage recommendation system recommends delaying the transferring the data if the class of the data is non-essential. And, if the computing device is on track to exceed the data usage limit during the time period, the data usage recommendation system recommends transferring the data at the current time if the class of the data is essential.

Additionally or alternatively, the data usage recommendation system receives a request from a program on the computing device to send or receive data, the request indicating a class of the data and an expiration time for transferring (e.g., sending or receiving) the data. The data usage recommendation system determines when to transfer the data based on the class of the data, the expiration time for transferring the data, and whether the computing device is on track to not exceed the data usage limit during the time period. For example, if the computing device is on track to not exceed the data usage limit during the time period, the data usage recommendation system determines to transfer the data at the current time. However, if the computing device is on track to exceed the data usage limit during the time period, then the data usage recommendation system delays transferring the data if the class of the data is non-essential and the expiration time has not elapsed. And, if the computing device is on track to exceed the data usage limit during the time period, then the data usage recommendation system transfers the data at the current time if the class of the data is essential and/or the expiration time has elapsed.

The techniques discussed herein allow determinations regarding the sending and/or receiving of data over a network to be made based on a data usage limit for a particular time period. By delaying transferring data that is not essential, the possibility of exceeding the data usage limit for the particular time period (or the amount that the data usage limit for the particular time period is exceeded) can be reduced. This results in more efficient usage of the data usage limit by the computing device, and reduces the cost of operating the computing device by reducing or avoiding excess data usage fees.

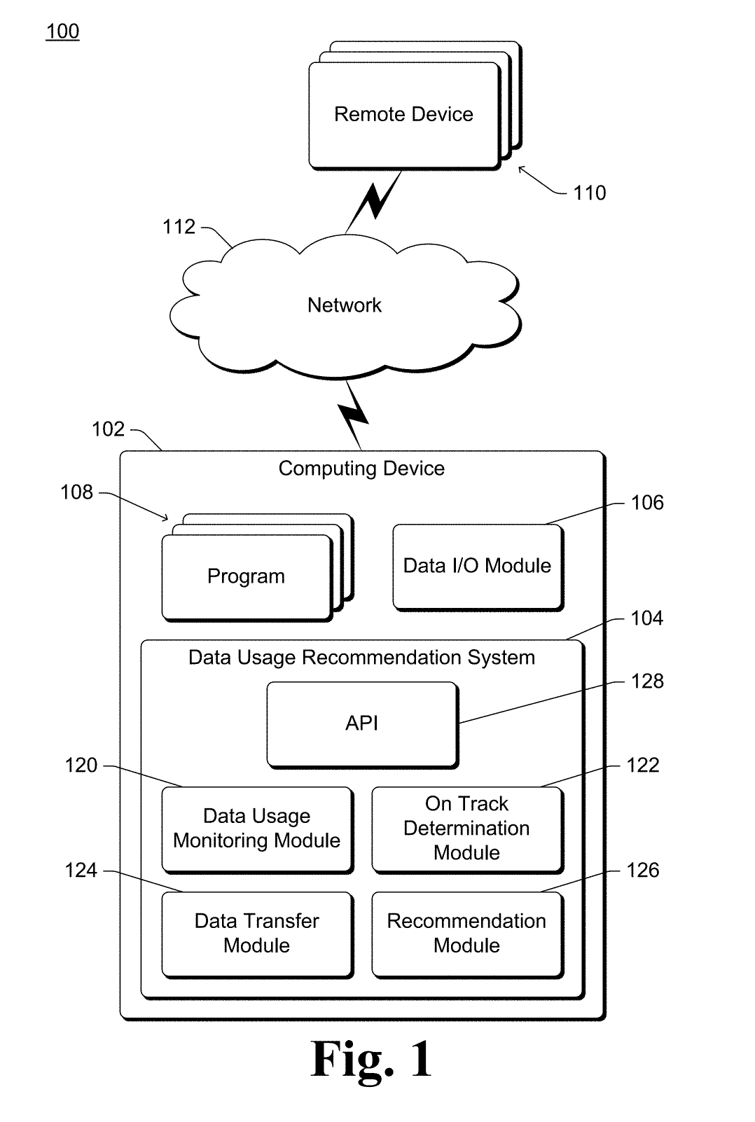

FIG. 1 is a block diagram illustrating an example system 100 implementing the data usage based data transfer determination in accordance with one or more embodiments. The system 100 includes a computing device 102, which can be a variety of different types of devices, such as a desktop computer, a server computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet, augmented reality (AR) headsets or devices, virtual reality (VR) headsets or devices), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, computing device 102 may range from a full resource device with substantial memory and processor resources (e.g., personal computers, game consoles) to a low-resource device with limited memory and/or processing resources (e.g., traditional set-top boxes, hand-held game consoles).

The computing device 102 includes a data usage recommendation system 104, a data I/O module 106, and one or more programs 108. The programs 108 can be various different applications that are run on the computing device 102 and/or operating system programs that are part of an operating system running on the computing device 102. The programs 108 can be, for example, utility programs, educational programs, productivity programs (e.g., spreadsheet programs, word processing programs), gaming programs, and so forth.

The data I/O module 106 manages data transfers between the computing device 102 and one or more remote devices 110 via a network 112. Each remote device 110 can be any of a variety of different types of computing devices, analogous to the computing device 102. The network 112 can be a variety of different networks, including the Internet, a local area network (LAN), a public telephone network, an intranet, other public and/or proprietary networks, combinations thereof, and so forth. The data I/O module 106 manages data transfers, which can include sending data to and/or receiving data from one or more remote devices 110, on behalf of programs 108 and/or data usage recommendation system 104. For example, the data I/O module 106 can receive from a program 108 data to be sent to a remote device 110 and/or an indication of data to be retrieved from a remote device 110.

The data usage recommendation system 104 includes a data usage monitoring module 120, an on track determination module 122, a data transfer module 124, a recommendation module 126, and an application programming interface (API) 128. The data usage monitoring module 120 monitors the amount of data that is transferred by the data I/O module 106 over various different time periods for a particular network 112. In one or more embodiments, the data usage monitoring module 120 monitors data usage over networks that have an associated data limit. This data limit can be a limit on the amount of data that can be transferred over a particular time period, can be a limit on the amount of data that can be transferred over a particular time period without incurring additional overage charges, and so forth. For example, the data usage can be usage of data on a data plan, also referred to as data plan usage, such as a data plan that a user signs up for allowing a particular number of gigabytes of data usage during some time period (e.g., a month) without incurring additional overage charges. In one or more embodiments, the data usage monitoring module 120 monitors data usage over a “costed” network, which refers to a network that a user pays to have a particular amount of access to. For example, the user may pay a certain amount of money in order to have access to a cellular network and the ability to transfer a certain amount of data over the cellular network in a given time period (e.g., 20 gigabytes per month). After that certain amount of data has been transferred, the user pays additional fees to transfer data during the given time period (e.g., a particular amount of money per additional gigabyte (or portion thereof) transferred).

In one or more embodiments, the data usage monitoring module 120 monitors data usage for a single network at a time. Additionally or alternatively, the data usage monitoring module 120 can monitor data usage for multiple networks. For example, the computing device 102 may be coupled to multiple different networks 112 at different times over the same or different time periods, and the data usage monitoring module 120 can monitor data usage over all of those multiple networks. E.g., during a given time period (e.g., one month), the computing device 102 may connect to two different networks each having a data usage limit, and the data usage monitoring module 120 can monitor data usage on both of these two different networks.

The data I/O module 106 can be specific to a particular network or alternatively may manage data transfers between the computing device 102 and one or more remote devices 110 via multiple different networks. The data usage monitoring module 120 receives an indication from the data I/O module 106 of the amount of data that is transferred (sent and/or received) via a network 112. In situations in which the data I/O module 106 manages data transfers via multiple different networks, the data I/O module 106 provides to the data usage monitoring module 120 an indication of how much data is transferred via each of the multiple different networks. In situations in which the data I/O module 106 manages data transfers for a single network, then the indication of how much data is transferred is inherently associated with the single network for which the data I/O module 106 manages data transfers.

The on track determination module 122 knows the data usage limit for a given time period for each network, and predicts whether the device is on track to not exceed the data usage limit during the time period. The on track determination module 122 can obtain the data usage limit and time periods for a network (e.g., the start date and/or time as well as the end date and/or time for each time period, as well as the data usage limit for that time period) in a variety of different manners. For example, the on track determination module 122 can obtain the data usage limit and time periods for a network from a user of the computing device 102, from another service over the network 112 (e.g., a service that provides access to the network), and so forth. The on track determination module 122 can determine the current date and/or time in various manners, such as from a clock or operating system component of the computing device 102. Given the data usage limit, the time period, and the current date and/or time, the on track determination module 122 makes a determination regarding whether the computing device 102 is on track to not exceed the data usage limit during a given time period.

The on track determination module 122 can determine whether the computing device 102 is on track to not exceed the data usage limit during a given time period in a variety of different manners. In one or more embodiments, the on track determination module 122 charts a linear progression from zero to the data usage limit over the given time period. Given the chart, the data usage so far during the current time period, and a current date and/or time in the current time period, whether the computing device 102 is on track to not exceed the data usage limit can be readily determined.

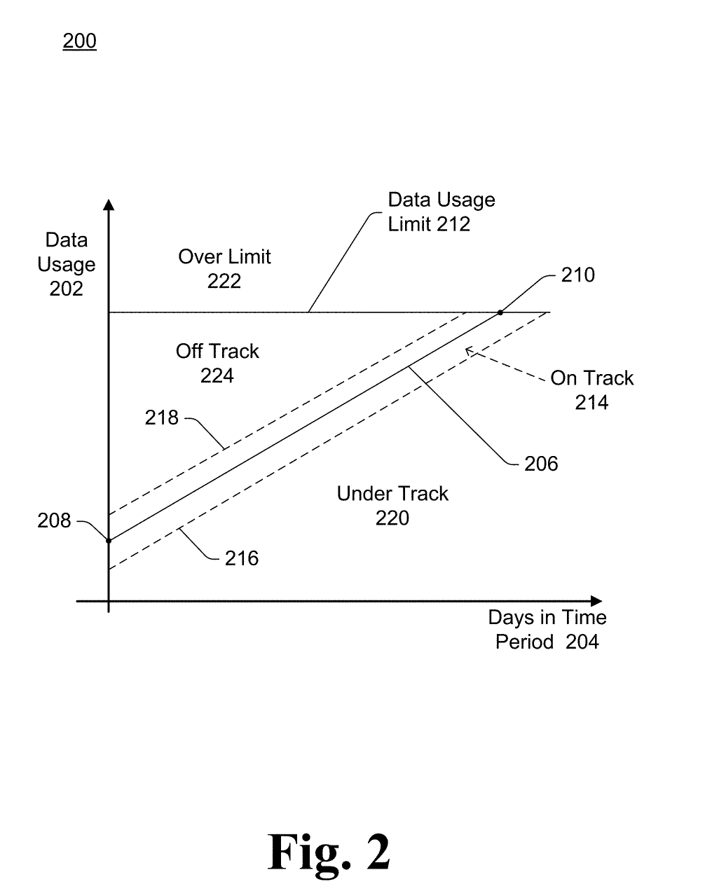

FIG. 2 illustrates an example chart 200 for determining whether the computing device 102 is on track to not exceed the data usage limit in accordance with one or more embodiments. The chart 200 illustrates data usage 202 along the vertical axis and days in the time period 204 along the horizontal axis. Although days in the time period are discussed with reference to FIG. 2, other granularities of time within the time period can alternatively be used (e.g., weeks, hours, 6-hour blocks, etc.).

A linear progression 206 starting with day 1 in the time period (shown at location 208) and ending at the last day in the time period (shown at location 210) is illustrated. The linear progression 206 indicates the amount of data usage, at various times during the time period, that equates to being on track to hit (but not exceed) the data usage limit 212 for the time period.

Given the current day in the time period and the data usage so far during the time period, a location in the chart 200 can be plotted. If this location is on the linear progression 206 or within a threshold amount (e.g., a fixed amount such as 100 megabytes or a variable amount such as 10% of the value on the linear progression 206 for the current day in the time period) of the linear progression 206, then the on track determination module 122 determines that the computing device 102 is on track to not exceed the data usage limit for the current time period. This area on the chart 200 where the computing device 102 is determined to be on track to not exceed the data usage limit for the current time period is shown as the area 214 between the dashed lines 216 and 218.

If the plotted location is below the dashed line 216, then the on track determination module 122 determines that the computing device 102 is below or under track to hit the data usage limit 212 for the time period. This is shown as under track portion 220. Thus, if the plotted location is below the dashed line 216, the on track determination module 122 determines that the computing device 102 is on track to not exceed the data usage limit 212 for the time period.

If the plotted location is above the data usage limit 212, then the on track determination module 122 determines that the computing device 102 is on track to exceed the data usage limit 212 for the time period (and actually already has exceeded the data usage limit 212 for the time period). This is shown as over limit portion 222.

If the plotted location is below the data usage limit 212 but above the dashed line 218, then the on track determination module 122 determines that the computing device 102 is on track to exceed the data usage limit 212 for the time period (and thus off track to not exceed the data usage limit 212 for the time period). This is shown as off track portion 224.

Although a linear progression 206 is illustrated in FIG. 2, additionally or alternatively the on track determination module 122 can use a non-linear progression. Rather than a linear progression, a line analogous to the line shown as linear progression 206 can be generated and used in the same manner as illustrated in FIG. 2 to identify the plotted locations that are on track, off track, and under track. Various different information can be used to generate the non-linear progression, such as previous patterns of usage of the computing device 102, predicted or anticipated usage of the computing device 102, and so forth.

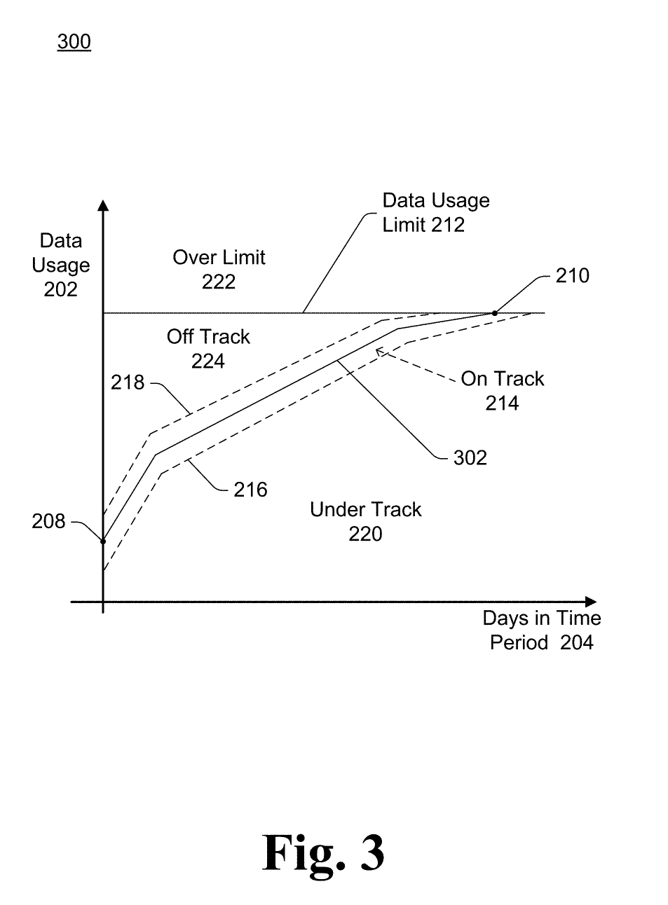

FIG. 3 illustrates an example chart 300 for determining whether the computing device 102 is on track to not exceed the data usage limit in accordance with one or more embodiments. In example chart 300, assume that the previous patterns of usage of the computing device 102 are that the user transfers a lot of data in the beginning of the time period and very little data at the end of the time period, the non-linear progression can have a slope that is larger in the beginning of the time period and smaller at the end of the time period. An example of such a non-linear progression is shown as non-linear progression 302. The chart 300 includes an off track portion 224, an under track portion 220, and an on track portion 214, although the locations of those portions 224, 220, and 214 are different due to the differences between non-linear progression 302 and linear progression 206 of FIG. 2.

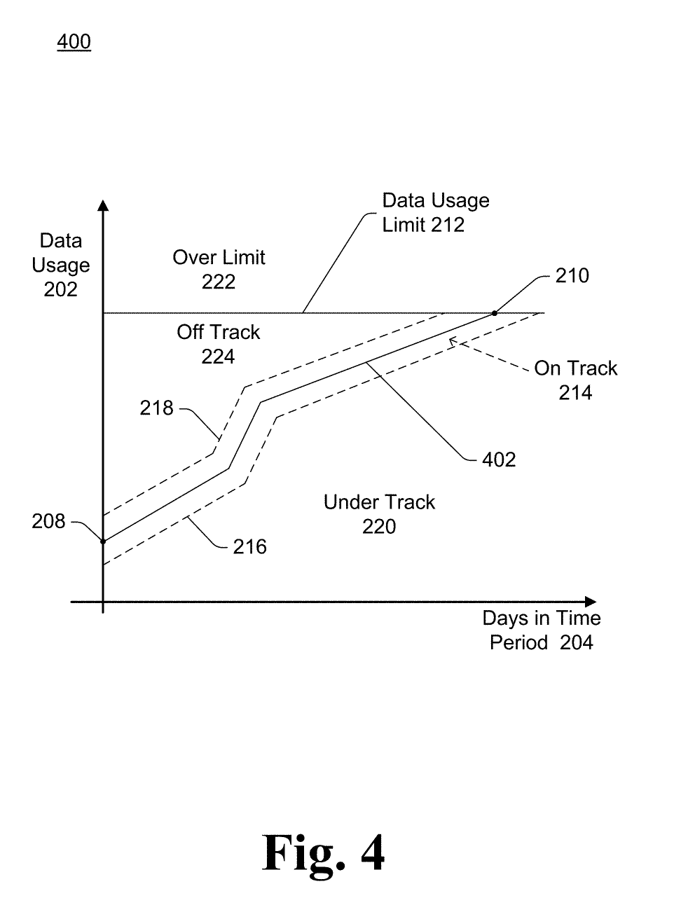

FIG. 4 illustrates an example chart 400 for determining whether the computing device 102 is on track to not exceed the data usage limit in accordance with one or more embodiments. In the example chart 400, assume that the computing device 102 is predicted to be away from the user's home or office (e.g., due to travel or meetings indicated in the user's calendar) in the middle of the time period, then the non-linear progression can have a slope that is larger in middle of the time period than at the beginning or end of the time period. An example of such a non-linear progression is shown as non-linear progression 402. The chart 400 includes an off track portion 224, an under track portion 220, and an on track portion 214, although the locations of those portions 224, 220, and 214 are different due to the differences between non-linear progression 402 and linear progression 206 of FIG. 2.

Returning to FIG. 1, the data usage recommendation system 104 includes an API 128 exposing one or more methods that can be invoked by a program 108 to invoke the functionality of the data usage recommendation system 104. In one or more embodiments, the API 128 includes a method that can be invoked by the program 108 to request a recommendation from the data usage recommendation system 104 regarding whether to transfer data at the current time or delay transferring the data. Additionally or alternatively, the API 128 includes a method that can be invoked by the program 108 to request that the data usage recommendation system 104 direct or manage a data transfer at the appropriate time (as determined by the data usage recommendation system 104).

The methods exposed by the API 128 can include various different parameters describing the desired data transfer. In one or more embodiments, a method exposed by the API 128 for a program 108 to request a recommendation or request that the data usage recommendation system direct or manage a data transfer includes a parameter that identifies the data. For data that is to be sent, the request can include the actual data to be sent or an identifier of where the data is located (e.g., a pointer to a memory location, a file name, a uniform resource identifier (URI), etc.). For data that is to be received, the request includes an identifier of where the data is to be retrieved from (e.g., a URI, a filename on a remote device 110, and so forth).

In one or more embodiments, a method exposed by the API 128 for a program 108 to request a recommendation or request that the data usage recommendation system direct or manage a data transfer includes a parameter that is an indication of the class of data to be transferred. Various different classes of data can be supported by the data usage recommendation system 104. In one or more embodiments, the classes of data supported by the data usage recommendation system 104 include a System:Pulse class, an App:Essential class, an App:Non-Essential class, a System:BackUp class, and a System:Telemetry class. Classes of data that begin with “System:” refer to data for a program 108 that is a system program (e.g., a program that is part of the operating system of the computing device 102), and classes of data that begin with “App:” refer to data for a program 108 that is an application program (e.g., a user application program or other program that is not part of the operating system of the computing device 102).

The System:Pulse class of data refers to data that a program 108 that is a system program desires to have transferred (e.g., sent) regardless of the cost (e.g., regardless of whether the computing device 102 is on track to not exceed the data usage limit over the time period). This class of data can be, for example, data that is essential to system operation and to satisfy business constraints (e.g., a health pulse or other signals indicating the health of the program or computing device 102 (but excluding at least some telemetry program telemetry data), licensing or census data, and so forth).

The App:Essential class of data refers to data that a program 108 that is an application program desires to have transferred regardless of the cost (e.g., regardless of whether the computing device 102 is on track to not exceed the data usage limit over the time period). This class of data can be, for example, user-requested data (e.g., articles), achievements completed or satisfied in the application program, and so forth.

The App:Non-Essential class of data refers to data that, for a program 108 that is an application program, is not essential to the program and that the program is willing to delay transfer of. This class of data can be, for example, updates to displays of tiles or icons on a screen, telemetry data (e.g., data indicating how the program is being used or the health of the program), and so forth.

The System:BackUp class of data refers to data that, for a program 108 that is a system program, is backup data. This backup data can be data for system wide back-ups, incremental back-ups, and so forth.

The System:Telemetry class of data refers to data that, for a program 108 that is a system program, is telemetry data for the program. The telemetry data for the program refers to data indicating how the program is being used or the health of the program.

In one or more embodiments, the different classes of data can be grouped together into two classes: essential and non-essential. The System:Pulse and App:Essential classes discussed above are each considered essential, and the App:Non-Essential, System:BackUp, and System:Telemetry are considered non-essential.

In one or more embodiments, a method exposed by the API 128 for a program 108 to request a recommendation or request that the data usage recommendation system direct or manage a data transfer includes a parameter that is the size or amount of data to be transferred. This size or amount can be indicated in various manners, such as a number of bytes.

In one or more embodiments, a method exposed by the API 128 for a program 108 to request a recommendation or request that the data usage recommendation system direct or manage a data transfer includes a parameter that is an expiration time. The expiration time is an indication of how long the program making requesting the data transfer is willing to wait for the data to be transferred. The expiration time can be specified in a variety of different manners, such as a countdown timer (e.g., from the time the request is made by the program, how long (e.g., how many minutes, hours, days, etc.) the programs is willing to wait for the data to be transferred), a timestamp (e.g., a date and/or time after which the program is no longer willing to wait for the data transfer), and so forth.

The computing device 102 is illustrated including data transfer module 124 and recommendation module 126. The data transfer module 124 manages or directs the transfer of data requested by program 108, including determining when to transfer the data. The data transfer is directed or managed based at least on the class of the data and whether the computing device 102 is on track to not exceed the data usage limit during the time period as determined by the on track determination module 122. Thus, the program 108 can request that data be transferred and rely on the data usage recommendation system 104 to transfer the requested data on behalf of the program 108.

The recommendation module 126 generates a recommendation regarding whether to transfer data at the current time or delay transferring the data, and returns the recommendation to the requesting program 108. The recommendation is generated based at least on the class of the data and whether the computing device 102 is on track to not exceed the data usage limit during the time period as determined by the on track determination module 122. Thus, the recommendation module 126 returns a recommendation to the program 108 regarding when to transfer the data and the program 108 manages or directs the transfer of data, including determining when to transfer the data. The data transfer module 124, on the other hand, manages or directs the transfer of data on behalf of the program 108.

Although the computing device 102 is illustrated including data transfer module 124 and recommendation module 126, the computing device 102 can alternatively include only one of the data transfer module 124 and the recommendation module 126. For example, if having the data usage recommendation system manage or direct data transfers is not desired, the data usage recommendation system 104 need not include the data transfer module 124. By way of another example, if having the programs 108 direct or manage data transfers themselves based on recommendations from the data usage recommendation system 104 is not desired, the data usage recommendation system 104 need not include the recommendation module 126.

The recommendation module 126 generates a recommendation regarding whether to transfer data at the current time or delay transferring the data, and returns the recommendation to the requesting program 108. In one or more embodiments, the recommendation is generated based at least in part on the class of the data and whether the computing device 102 is on track to not exceed the data usage limit during the time period as determined by the on track determination module 122. The recommendation module 126 can also use various additional information provided to the data usage recommendation system 104 (e.g., by the program 108 along with the request for the recommendation) to generate the recommendation. This additional information can include, for example, a size of the data to be transferred, an expiration time for the data transfer, a prediction of when the computing device 102 will next be able to connect to a “free” network (a network that a user does not pay to have a particular amount of access to), and so forth. The recommendation module 126 can apply various different rules or criteria to this information to generate the recommendation.

For example, if the on track determination module 122 determines that the computing device 102 is on track to not exceed the data usage limit during the current time period, then the recommendation module 126 generates a recommendation to transfer the data at the current time. However, if the on track determination module 122 determines that the computing device 102 is on track to exceed the data usage limit during the time period and the class of the data to be transferred is non-essential, then the recommendation module 126 generates a recommendation to delay transferring the data. And, if the on track determination module 122 determines that the computing device 102 is on track to exceed the data usage limit during the time period and the class of the data to be transferred is essential, then the recommendation module 126 generates a recommendation to transfer the data at the current time.

The recommendation module 126 can also factor in other information regarding the data transfer in generating the recommendation. For example, if the request includes an expiration time for transferring the data, and the expiration time has elapsed, then the recommendation module 126 can generate a recommendation to transfer the data at the current time. By way of another example, if the request includes a size of the data to be transferred and the class of the data is non-essential, and if the on track determination module 122 determines that the computing device 102 is currently on track to not exceed the data usage limit during the time period but transferring data of the requested size (e.g., 1 gigabyte) would put the computing device 102 on track to exceed the data usage limit during the time period, then the recommendation module 126 can generate a recommendation to delay transferring the data.

By way of another example, a prediction of when the computing device 102 will next be able to connect to a free network can be obtained or generated by the recommendation module 126. This prediction can be generated in a variety of different manners, such as based on entries in a user's calendar (e.g., an upcoming meeting scheduled at the user's home or office where access to a free network is available), based on previous patterns of usage or behavior (e.g., the computing device 102 is typically (e.g., greater than a threshold amount of time) coupled to a free network at particular times of particular days), and so forth. If the computing device is predicted to be able to connect to a free network soon (e.g., within a threshold amount of time, such as 10 minutes) and the class of the data to be transferred is non-essential, then the recommendation module 126 generates a recommendation to delay transferring the data.

The data transfer module 124 manages or directs the transfer of data requested by program 108, including determining when to transfer the data. In one or more embodiments, the determination is made based at least in part on the class of the data and whether the computing device 102 is on track to not exceed the data usage limit during the time period as determined by the on track determination module 122. The data transfer module 124 can also use various additional information provided to the data usage recommendation system 104 (e.g., by the program 108 along with the request for the recommendation) to transfer the data. This additional information can include, for example, a size of the data to be transferred, an expiration time for the data transfer, and so forth. The data transfer module 124 can apply various different rules or criteria to this information to generate the recommendation.

For example, if the on track determination module 122 determines that the computing device 102 is on track to not exceed the data usage limit during the current time period, then the data transfer module 124 determines to transfer the data at the current time. However, if the on track determination module 122 determines that the computing device 102 is on track to exceed the data usage limit during the time period and the class of the data to be transferred is non-essential, then the data transfer module 124 determines to delay transferring the data. The data can be buffered as appropriate by the data usage recommendation system 104 until a determination is subsequently made to transfer the data. This delay can continue until various events occur, such as the computing device 102 is connected to a different network, until the on track determination module 122 determines that the computing device 102 is no longer on track to exceed the data usage limit during the time period, the class of the data is changed (e.g., by the program 108) to essential, an expiration time for transferring the data has elapsed, and so forth. Additionally, if the on track determination module 122 determines that the computing device 102 is on track to exceed the data usage limit during the time period and the class of the data to be transferred is essential, then the data transfer module 124 determines to transfer the data at the current time.

The data transfer module 124 can also factor in other information regarding the data transfer in determining when to transfer the data. For example, if the request includes an expiration time for transferring the data, and the expiration time has elapsed, then the data transfer module 124 can determine to transfer the data at the current time. By way of another example, if the request includes a size of the data to be transferred and the class of the data is non-essential, and if the on track determination module 122 determines that the computing device 102 is currently on track to not exceed the data usage limit during the time period but transferring data of the requested size (e.g., 1 gigabyte) would put the computing device 102 on track to exceed the data usage limit during the time period, then the data transfer module 124 can determine to delay transferring the data.

By way of another example, a prediction of when the computing device 102 will next be able to connect to a free network can be obtained or generated by the data transfer module 124. This prediction can be generated in a variety of different manners, such as based on entries in a user's calendar (e.g., an upcoming meeting scheduled at the user's home or office where access to a free network is available), based on previous patterns of usage or behavior (e.g., the computing device 102 is typically (e.g., greater than a threshold amount of time) coupled to a free network at particular times of particular days), and so forth. If the computing device is predicted to be able to connect to a free network soon (e.g., within a threshold amount of time, such as 10 minutes) and the class of the data to be transferred is non-essential, then the data transfer module 124 can determine to delay transferring the data.

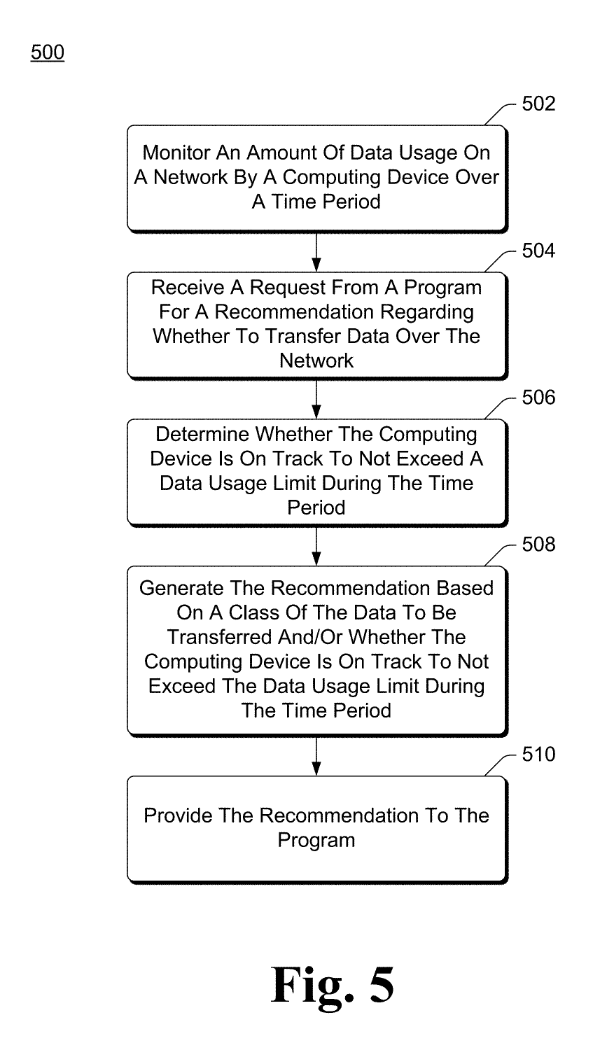

FIG. 5 is a flowchart illustrating an example process 500 for implementing the data usage based data transfer determination in accordance with one or more embodiments. Process 500 is carried out by a device, data usage recommendation system, such as data usage recommendation system 104 of FIG. 1, and can be implemented in software, firmware, hardware, or combinations thereof. Process 500 is shown as a set of acts and is not limited to the order shown for performing the operations of the various acts. Process 500 is an example process for implementing the data usage based data transfer determination; additional discussions of implementing the data usage based data transfer determination are included herein with reference to different figures.

In process 500, an amount of data usage on a network by a computing device over a time period is monitored (act 502). The time period can be varying lengths, such as a billing cycle for a user of the computing device implementing the data usage recommendation system.

A request is received from a program for a recommendation regarding whether to transfer data over the network (act 504). This transfer can be sending and/or receiving data over the network. This request can include various additional information as discussed above, such as a size of the data, and expiration time for transferring the data, and so forth.

A determination is made as to whether the computing device is on track to not exceed a data usage limit during the time period (act 506). This determination is made based on the data usage and optionally various additional information (e.g., predicted or anticipated future usage) as discussed above.

A recommendation is generated based on a class of the data to be transferred and/or whether the computing device is on track to not exceed the data usage limit during the time period (act 508). The recommendation can additionally or alternatively be generated based on additional information, such as a size of the data to be transferred, an expiration time for transferring the data, and so forth.

The recommendation generated in act 508 is provided to the program (act 510). The recommendation is provided to the program that requested the recommendation, and that program can subsequently determine when to transfer the data based on the provided recommendation.

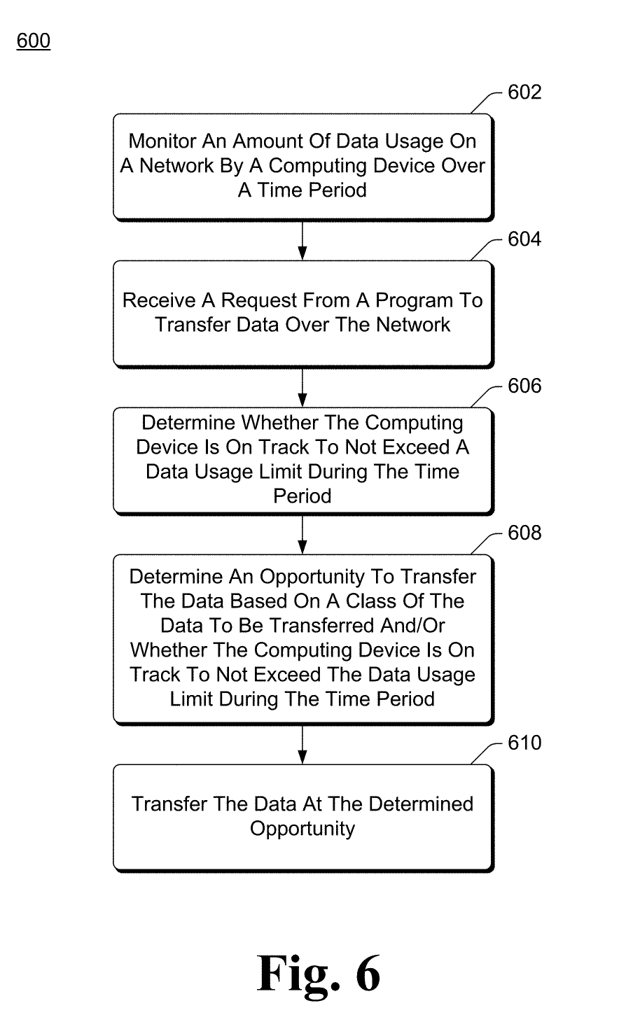

FIG. 6 is a flowchart illustrating an example process 600 for implementing the data usage based data transfer determination in accordance with one or more embodiments. Process 600 is carried out by a device, data usage recommendation system, such as data usage recommendation system 104 of FIG. 1, and can be implemented in software, firmware, hardware, or combinations thereof. Process 600 is shown as a set of acts and is not limited to the order shown for performing the operations of the various acts. Process 600 is an example process for implementing the data usage based data transfer determination; additional discussions of implementing the data usage based data transfer determination are included herein with reference to different figures.

In process 600, an amount of data usage on a network by a computing device over a time period is monitored (act 602). The time period can be varying lengths, such as a billing cycle for a user of the computing device implementing the data usage recommendation system.

A request is received from a program to transfer data over the network (act 604). This transfer can be sending and/or receiving data over the network. This request can include various additional information as discussed above, such as a size of the data, and expiration time for transferring the data, and so forth.

A determination is made as to whether the computing device is on track to not exceed a data usage limit during the time period (act 606). This determination is made based on the data usage and optionally various additional information (e.g., predicted or anticipated future usage) as discussed above.

An opportunity to transfer the data is determined based on a class of the data to be transferred and/or whether the computing device is on track to not exceed the data usage limit during the time period (act 608). The determination can additionally or alternatively be generated based on additional information, such as a size of the data to be transferred, an expiration time for transferring the data, and so forth. The determination can be, for example, to transfer the data at the current time or to delay transferring the data (e.g., until some other event occurs).

The data is then transferred at the determined opportunity (act 610). An indication of the data transfer (e.g., the received data) can optionally be returned to the requesting program. For example, the data transfer can be delayed, and occur at a later time when some other event occurs (e.g., the computing device is connected to a free network).

Returning to FIG. 1, the techniques discussed herein allow for the programs 108 to take into account data usage and data usage limits over a network in determining when to transfer data. In contrast to simply waiting to transfer data until the computing device 102 has access to a network that doesn't have a data usage limit (or has a much lower cost), the techniques discussed herein allow for the transfer of data over costed (or higher cost) networks if the data usage limit for that network is not expected to be exceeded.

The techniques discussed herein support various different usage scenarios. For example, assume a user Hope has a costed data plan that she pays a certain amount of money for per billing cycle, and that costs her extra money if she exceeds the data usage limit for the data plan during the billing cycle. Hope depends on the Start screen on her phone to get timely updates at a glance. She typically runs high on her data plan consumption towards the end of her billing cycle. The data usage recommendation system can give application authors guidance to prevent background data from aggressively eating into her plan. Applications can partition their data transfers into appropriate buckets (e.g., classes of data) and pace the data usage for the plan more effectively. Hope gets slower updates to her Start screen as her consumption of her data plan increases. Applications scale back the frequency of their eventual traffic, and delay or discard non-essential traffic, on costed networks, preventing her from avoidable cost overruns in her data plan. As soon as free networks are available, Hope gets full speed updates to her Start screen again. And, if an application defined expiration time elapses, Hope gets important updates, even on costed networks, ensuring she gets important updates in a timely manner.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

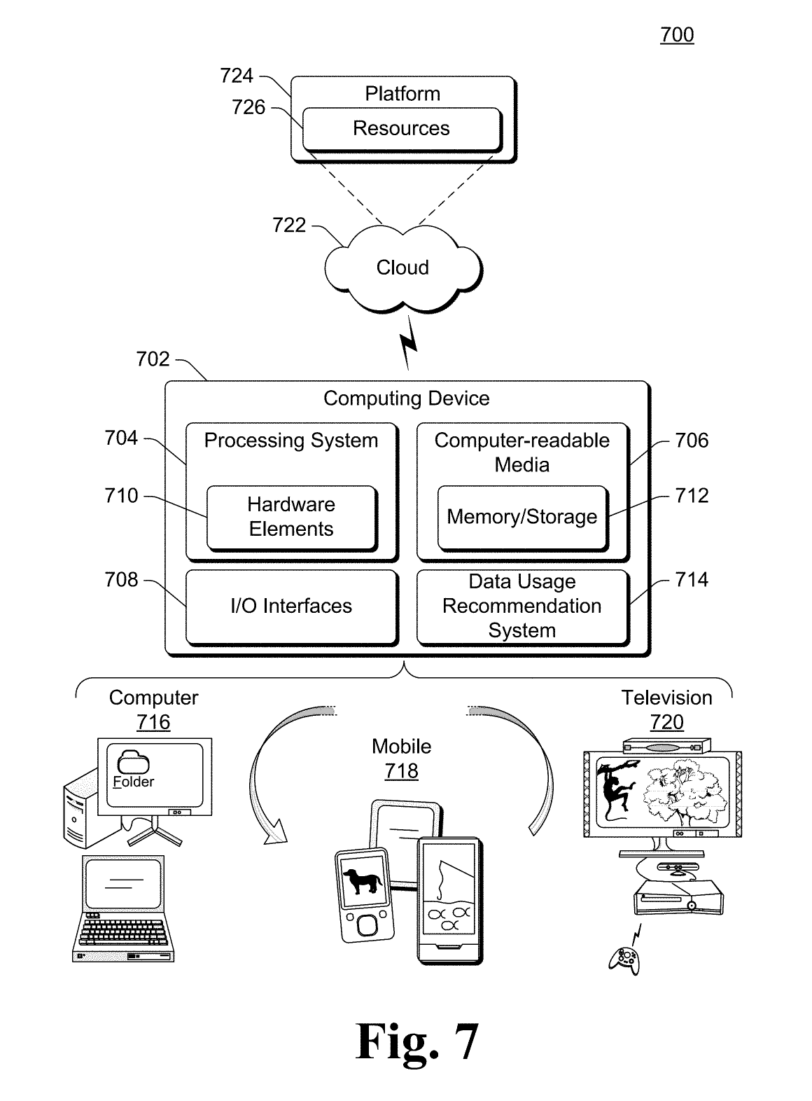

FIG. 7 illustrates an example system generally at 700 that includes an example computing device 702 that is representative of one or more systems and/or devices that may implement the various techniques described herein. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O Interfaces 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware elements 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 706 is illustrated as including memory/storage 712. The memory/storage 712 represents memory/storage capacity associated with one or more computer-readable media. The memory/storage 712 may include volatile media (such as random access memory (RAM)) and/or nonvolatile media (such as read only memory (ROM), Resistive RAM (ReRAM), Flash memory, optical disks, magnetic disks, and so forth). The memory/storage 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

The one or more input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 702 may be configured in a variety of ways as further described below to support user interaction.

The computing device 702 also includes a data usage recommendation system 714. The data usage recommendation system 714 provides various data transfer recommendations and/or management as discussed above. The data usage recommendation system 714 can implement, for example, the data usage recommendation system 104 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 710 and computer-readable media 706 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of modules as a module that is executable by the computing device 702 as software may be achieved at least partially in hardware, e.g., through use of computer-readable storage media and/or hardware elements 710 of the processing system. The instructions and/or functions may be executable/operable by one or more articles of manufacture (for example, one or more computing devices 702 and/or processing systems 704) to implement techniques, modules, and examples described herein.

As further illustrated in FIG. 7, the example system 700 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 700, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 702 may assume a variety of different configurations, such as for computer 716, mobile 718, and television 720 uses. Each of these configurations includes devices that may have generally different constructs and capabilities, and thus the computing device 702 may be configured according to one or more of the different device classes. For instance, the computing device 702 may be implemented as the computer 716 class of a device that includes a personal computer, desktop computer, a multi-screen computer, laptop computer, netbook, and so on.

The computing device 702 may also be implemented as the mobile 718 class of device that includes mobile devices, such as a mobile phone, portable music player, portable gaming device, a tablet computer, a multi-screen computer, and so on. The computing device 702 may also be implemented as the television 720 class of device that includes devices having or connected to generally larger screens in casual viewing environments. These devices include televisions, set-top boxes, gaming consoles, and so on.

The techniques described herein may be supported by these various configurations of the computing device 702 and are not limited to the specific examples of the techniques described herein. This functionality may also be implemented all or in part through use of a distributed system, such as over a “cloud” 722 via a platform 724 as described below.

The cloud 722 includes and/or is representative of a platform 724 for resources 726. The platform 724 abstracts underlying functionality of hardware (e.g., servers) and software resources of the cloud 722. The resources 726 may include applications and/or data that can be utilized while computer processing is executed on servers that are remote from the computing device 702. Resources 726 can also include services provided over the Internet and/or through a subscriber network, such as a cellular or Wi-Fi network.

The platform 724 may abstract resources and functions to connect the computing device 702 with other computing devices. The platform 724 may also serve to abstract scaling of resources to provide a corresponding level of scale to encountered demand for the resources 726 that are implemented via the platform 724. Accordingly, in an interconnected device embodiment, implementation of functionality described herein may be distributed throughout the system 700. For example, the functionality may be implemented in part on the computing device 702 as well as via the platform 724 that abstracts the functionality of the cloud 722.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented in a computing device, the method comprising: monitoring an amount of data usage on a network by the computing device over a time period; receiving, from a program, a request for a recommendation regarding whether to transfer data over the network, the data being one of multiple classes; determining, based on the amount of data usage and a data usage limit on the network for the time period, whether the computing device is on track to not exceed the data usage limit during the time period; generating the recommendation based on the class of the data and whether the computing device is on track to not exceed the data usage limit during the time period; and providing the recommendation to the program.

Alternatively or in addition to any of the above described methods, any one or combination of: the generating the recommendation further comprising generating the recommendation based on a size of the data to be transferred; the generating the recommendation comprising generating a recommendation to transfer the data at the current time in response to determining that the computing device is on track to not exceed the data usage limit during the time period; the generating the recommendation comprising generating a recommendation to transfer the data at the current time in response to determining that the class of the data is essential; the generating the recommendation comprising generating a recommendation to delay transferring the data in response to determining that the computing device is on track to exceed the data usage limit during the time period and that the class of the data is non-essential; the network comprising a cellular data network and the data usage limit comprising a data plan data usage limit for a billing cycle below which additional overage charges are not incurred; the request for a recommendation regarding whether to transfer data over the network comprising a request for a recommendation regarding whether to send data over the network to a remote device; the request for a recommendation regarding whether to transfer data over the network comprising a request for a recommendation regarding whether to receive data over the network from a remote device.

A method implemented in a computing device, the method comprising: monitoring an amount of data usage on a network by the computing device over a time period; receiving, from a program, a request to transfer data over a network, the request including an indication of a class of the data; determining, based on the amount of data usage and a data usage limit on the network for the time period, whether the computing device is on track to not exceed the data usage limit during the time period; determining, based on the class of the data and whether the computing device is on track to not exceed the data usage limit during the time period, an opportunity to transfer the data; and transferring the data at the determined opportunity.

Alternatively or in addition to any of the above described methods, any one or combination of: the determining the opportunity to transfer the data further comprising determining the opportunity to transfer the data based on a size of the data; the determining the opportunity to transfer the data comprising determining to transfer the data at the current time in response to determining that the computing device is on track to not exceed the data usage limit during the time period; the determining the opportunity to transfer the data comprising determining to transfer the data at the current time in response to determining that the class of the data is essential; the determining the opportunity to transfer the data comprising determining to delay transferring the data in response to determining that the class of the data is non-essential; the network comprising a cellular data network and the data usage limit comprising a data plan data usage limit for a billing cycle below which additional overage charges are not incurred; further comprising receiving an expiration time for transferring the data, and the determining the opportunity to transfer the data comprising determining to transfer the data at the current time in response to the expiration time for transferring the data having elapsed; the transferring the data comprising sending and/or receiving the data.

A computing device comprising: one or more processors; and a computer-readable storage medium having stored thereon multiple instructions that, responsive to execution by the one or more processors, cause the one or more processors to: monitor an amount of data usage on a network by the computing device over a time period; receive, from a program running on the computing device, a request for a recommendation regarding whether to transfer data over the network; determine, based on the amount of data usage and a data usage limit on the network for the time period, whether the computing device is on track to not exceed the data usage limit during the time period; generate the recommendation based on a class of the data and whether the computing device is on track to not exceed the data usage limit during the time period; and provide the recommendation to the program.

Alternatively or in addition to any of the above described computing devices, any one or combination of: wherein to generate the recommendation is to generate a recommendation to transfer the data at the current time in response to determining that the computing device is on track to not exceed the data usage limit during the time period; wherein to generate the recommendation is to generate a recommendation to delay transferring the data in response to determining that the computing device is on track to not exceed the data usage limit during the time period but, based on a size of the data transfer, that the computing device would be on track to exceed the data usage limit during time period if the data transfer were to be performed at the current time; wherein to generate the recommendation is to generate a recommendation to delay transferring the data in response to determining that the computing device is on track to exceed the data usage limit during the time period and that the class of the data is non-essential.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method implemented in a computing device, the method comprising:
monitoring an amount of data usage on a network by the computing device over a time period;
receiving, from a program, a request for a recommendation regarding data to be transferred over the network, the data to be transferred being classified as essential or non-essential;
determining, based on the amount of data usage and a data usage limit on the network for the time period, whether the computing device is on track to not exceed the data usage limit during the time period;
generating the recommendation based on whether the data to be transferred is essential or non-essential and whether the computing device is on track to not exceed the data usage limit during the time period; and
providing the recommendation to the program.

2. The method as recited in claim 1, the generating the recommendation further comprising generating the recommendation based on a size of the data to be transferred.

3. The method as recited in claim 1, the generating the recommendation comprising generating a recommendation to transfer the data at the current time in response to determining that the computing device is on track to not exceed the data usage limit during the time period.

4. The method as recited in claim 1, the generating the recommendation comprising generating a recommendation to transfer the data at the current time in response to determining that the class of the data to be transferred is essential.

5. The method as recited in claim 1, the generating the recommendation comprising generating a recommendation to delay transferring the data in response to determining that the computing device is on track to exceed the data usage limit during the time period and that the class of the data to be transferred is non-essential.

6. The method as recited in claim 1, the network comprising a cellular data network and the data usage limit comprising a data plan data usage limit for a billing cycle below which additional overage charges are not incurred.

7. The method as recited in claim 1, the request for a recommendation regarding whether to transfer data over the network comprising a request for a recommendation regarding whether to send the data to be transferred over the network to a remote device.

8. The method as recited in claim 1, the request for a recommendation regarding whether to transfer data over the network comprising a request for a recommendation regarding whether to receive the data to be transferred over the network from a remote device.

9. A method implemented in a computing device, the method comprising:
monitoring an amount of data usage on a network by the computing device over a time period;
receiving, from a program, a request to transfer data over a network, the request including an indication of whether the data to be transferred is classified as essential or non-essential;
determining, based on the amount of data usage and a data usage limit on the network for the time period, whether the computing device is on track to not exceed the data usage limit during the time period;
determining, based on whether the data to be transferred is classified as essential or non-essential and whether the computing device is on track to not exceed the data usage limit during the time period, an opportunity to transfer the data; and
transferring the data at the determined opportunity.

10. The method as recited in claim 9, the determining the opportunity to transfer the data further comprising determining the opportunity to transfer the data based on a size of the data.

11. The method as recited in claim 9, the determining the opportunity to transfer the data comprising determining to transfer the data at the current time in response to determining that the computing device is on track to not exceed the data usage limit during the time period.

12. The method as recited in claim 9, the determining the opportunity to transfer the data comprising determining to transfer the data at the current time in response to determining that the class of the data is essential.

13. The method as recited in claim 9, the determining the opportunity to transfer the data comprising determining to delay transferring the data in response to determining that the class of the data is non-essential.

14. (canceled)

15. The method as recited in claim 9, further comprising receiving an expiration time for transferring the data, and the determining the opportunity to transfer the data comprising determining to transfer the data at the current time in response to the expiration time for transferring the data having elapsed.

16. (canceled)

17. A computing device comprising:
one or more processors; and
a computer-readable storage medium having stored thereon multiple instructions that, responsive to execution by the one or more processors, cause the one or more processors to:
monitor an amount of data usage on a network by the computing device over a time period;
receive, from a program running on the computing device, a request for a recommendation regarding data to be transferred over the network, the data being classified as essential or non-essential;
determine, based on the amount of data usage and a data usage limit on the network for the time period, whether the computing device is on track to not exceed the data usage limit during the time period;
generate the recommendation based whether the data to be transferred is essential or non-essential and whether the computing device is on track to not exceed the data usage limit during the time period; and
provide the recommendation to the program.

18. The computing device as recited in claim 17, wherein to generate the recommendation is to generate a recommendation to transfer the data at the current time in response to determining that the computing device is on track to not exceed the data usage limit during the time period.

19. The computing device as recited in claim 17, wherein to generate the recommendation is to generate a recommendation to delay transferring the data in response to determining that the computing device is on track to not exceed the data usage limit during the time period but, based on a size of the data transfer, that the computing device would be on track to exceed the data usage limit during time period if the data transfer were to be performed at the current time.

20. The computing device as recited in claim 17, wherein to generate the recommendation is to generate a recommendation to delay transferring the data in response to determining that the computing device is on track to exceed the data usage limit during the time period and that the class of the data is non-essential.

21. The method as recited in claim 1, wherein the data to be transferred is classified as essential in response to the data to be transferred being one or more of data signaling health of a program of an operating system of the computing device, data signaling health of the computing device, licensing data, census data, or user-requested data.

22. The method as recited in claim 1, wherein the data to be transferred is classified as non-essential in response to the data to be transferred being one or more of data for an application program on the computing device that the application program is willing to delay transfer of, backup data for a program of an operating system of the computing device, or telemetry data for a system program.
